(19) United States
(12) Patent Application Publication
(10) Pub. No.: US 2013/0166079 A1
(43) Pub. Date: Jun. 27, 2013

(54) MOBILE, PERSONAL, OPEN-LOOP COOLING SYSTEMS AND METHODS

(71) Applicants: Kurt R. Wilhelm, Wauconda, IL (US); David J. Sykes, Marseille (FR)

(72) Inventors: Kurt R. Wilhelm, Wauconda, IL (US); David J. Sykes, Marseille (FR)

(21) Appl. No.: 13/336,971

(22) Filed: Dec. 23, 2011

(51) Int. Cl. G05D 23/19; F25D 31/00; G05D 7/06; F25B 41/00

(52) U.S. Cl. 700/282; 62/216; 62/56

(57) ABSTRACT

Open-loop cooling systems and methods are provided which can be used in many different capacities, including as mobile, personal cooling systems for people engaging in strenuous activities or working in situations where body temperature maintenance is a concern. Efficient use of refrigerant in combination with phase change material provides sustained cooling capability in some embodiments.

### DISCUSSION OF THE RELATED ART

Heat-related illnesses are a concern and danger to people who are working in harsh environmental conditions and/or wearing clothing or personal protective equipment that limit the release of body heat. For example, soldiers are often expected to operate in extreme conditions while wearing uniforms, body armor, and heavy gear. Biohazard protective suits, hazardous materials protective suits, explosive ordinance disposal (EOD) suits, and radiation protective suits are some examples of personal protective equipment which trap body heat and can accelerate heat-related illnesses or heat discomfort. Maintaining a controlled body temperature in such circumstances can be challenging.

### SUMMARY

Embodiments provided herein are directed to open-loop cooling systems and methods which can be used in many different capacities, including as mobile, personal cooling systems for people engaging in strenuous activities or working in situations where body temperature maintenance is a concern.

According to one embodiment, a user-wearable, open-loop cooling system includes an evaporator configured to receive a refrigerant from a refrigerant supply, and further configured to release evaporated refrigerant. A phase change material is provided which is configured to be cooled by the evaporator. The system includes a user-wearable carrier configured to hold the evaporator and the phase change material on a user's body. Also included is a first sensor configured to sense a first property of the system, the first sensed parameter being related to a state of refrigerant which is in the evaporator or which is being released from the evaporator A controller is configured to control introduction of the refrigerant to the evaporator, wherein the control of the introduction of refrigerant to the evaporator is based at least in part on a value of the first sensed parameter.

According to another embodiment, a method of cooling a user's body includes an act of donning a user-wearable, open-loop cooling system. The system includes an evaporator configured to receive a refrigerant from a refrigerant supply, and the evaporator being further configured to release evaporated refrigerant. The system also includes a phase change material configured to be cooled by the evaporator. According to the method, a first parameter of the system is sensed, the first sensed parameter being related to a state of the refrigerant in the evaporator. The method further includes controlling introduction of the refrigerant to the evaporator based at least in part on a value of the first sensed parameter.

According to a further embodiment, at least one computer-readable storage medium contains computer-readable instructions which, when executed by a processor, perform a method of controlling an open-loop cooling system. The cooling system includes an evaporator configured to receive a refrigerant from a refrigerant supply and further configured to release evaporated refrigerant, a phase change material configured to be cooled by the evaporator, and a user-wearable carrier configured to hold the evaporator and the phase change material on a user's body. The method includes an act of receiving a value of a first sensed parameter of the system, the first sensed parameter being related to a state of the refrigerant in the evaporator. The method further includes an act of controlling introduction of the refrigerant to the evaporator based at least in part on a value of the first sensed parameter.

According to yet another embodiment, a user-wearable, open-loop cooling system includes an evaporator configured to receive a refrigerant from a refrigerant supply, and further configured to release evaporated refrigerant. The system also has a mass of cooling material configured to be cooled by the evaporator. A user-wearable carrier is provided to hold the evaporator and the cooling material on a user's body. A first sensor is configured to sense a first property of the system, the first sensed parameter being related to a state of refrigerant which is in the evaporator or which is being released from the evaporator. The system also includes a controller configured to control introduction of the refrigerant to the evaporator, wherein the control of the introduction of refrigerant to the evaporator is based at least in part on a value of the first sensed parameter.

According to a further embodiment, a method of cooling an object with an open-loop cooling system is provided. The system includes an evaporator configured to receive a refrigerant from a refrigerant supply, with the evaporator being further configured to release evaporated refrigerant. The system also includes a cooling mass, such as a phase change material, configured to be cooled by the evaporator. According to the method, the system is placed in, on or around an object such that the cooling mass is thermally coupled to the object. A first parameter of the system is sensed, the first sensed parameter being related to a state of the refrigerant in the evaporator. In a further act, introduction of the refrigerant to the evaporator is controlled based at least in part on a value of the first sensed parameter. The system may be used to maintain a cool temperature in a container such as a cooler.

### BRIEF DESCRIPTION OF DRAWINGS

Aspects of the invention are described below with reference to the following drawings in which like numerals reference like elements The accompanying drawings are not intended to be drawn to scale. For purposes of clarity, not every component may be labeled in every drawing. In the drawings:

FIG. 1 is a perspective view of a user wearing a mobile, personal cooling system according to one embodiment of the invention;

FIG. 2 is a schematic diagram of the components of a mobile, personal cooling system according to one embodiment of the invention;

FIGS. 3a and 3b show a flowchart of a method of controlling the cooling system shown in FIG. 2;

FIG. 4 is a flowchart of a method of controlling a cooling system according to another embodiment; and

FIG. 5 is a perspective view of a mobile open-loop cooling system according to another embodiment.

### DETAILED DESCRIPTION

Personal conductive coolers, such as ice packs and water circulation garments, provide cooling for a limited amount of time before the cooling material warms and has to be exchanged for further ice packs or cooled water. To extend the effective cooling time before an exchange has to occur, either the mass of the initial cooling material is increased, and/or the temperature of the initial cooling material is decreased. Of course, both of these options have practical limits when used as part of a mobile, personal cooling system.

Convective coolers, such as fans and closed loop air conditioners which use a vapor compression cycle, require a continuous energy supply—typically in the form of electricity. Even if the weight concerns associated with the components of such systems are addressed, providing a continuous electrical supply that is both mobile and sufficient to provide cooling for an extended period of time is difficult.

The inventors have appreciated that an efficiently operated open-loop cooling system can be used to cool a user or articles for an extended period time in a practical manner. In some embodiments, an open-loop cooling system may be combined with a phase change material to further improve the efficacy of the system.

An open-loop cooling system avoids the need for vapor compression components and the storage of on-board energy to operate the vapor compressor. Instead, the cooling capacity of embodiments disclosed herein is provided by a supply of refrigerant and a previously-cooled phase change material (though in some embodiments, the phase change material is not pre-cooled). When used efficiently in conjunction with a phase change material, embodiments may cool a user for many hours with a single container of refrigerant. For example, in some embodiments, 8-12 hours of cooling, or even more, may be provided with a single container in a practical manner. When replacement refrigerant containers are available, the system can be continuously used endlessly. Embodiments of methods and systems for efficiently controlling an open-loop cooling system are provided herein. A non-combustible, non-flammable, non-toxic and natural refrigerant may be used in some embodiments.

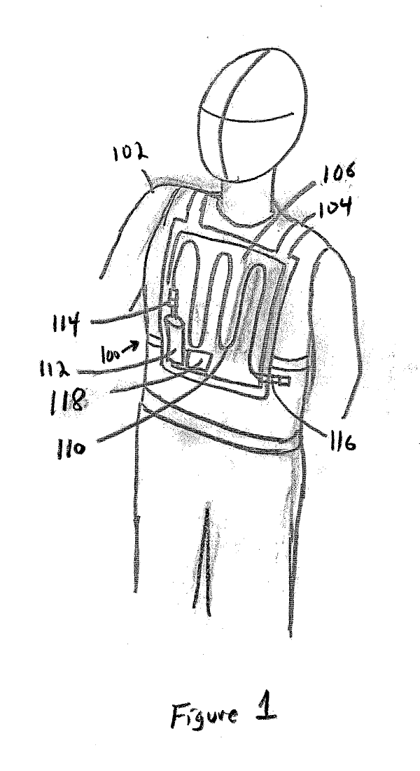

One embodiment of a mobile, personal cooling system 100 is shown being worn by a user 102 in FIG. 1. In this embodiment, cooling system 100 is being held on the user's body by a carrier which includes straps 104. In some embodiments, portions of cooling system 100, or the entire cooling system, may be inserted into or otherwise incorporated in a garment such as a vest or a protective suit. For example, in one embodiment, cooling system 100 may be attached to the exterior of a vest such that when the vest is worn by user 102, the interior of the vest material contacts the user's skin, and the cooling material of cooling system 100 is positioned on the exterior of the vest material. Undergarments may be worn so that the interior of the vest material does not directly contact the user's skin. In other embodiments, the cooling system may be incorporated entirely within a garment, and in some cases the cooling system may be removable from the garment by the user. For example, a garment may include a pocket or pockets configured to removably hold components of the cooling system. The cooling system also may be used to cool medical patients, and in this regard may be used by placing the cooling system on the patient. For such a use, the system may be incorporated into a blanket or a mattress, or used in any suitable configuration where the cooling material can be held against a portion of the patient's body.

Cooling system 100 includes a cooling material, such as a phase change material 106. To cool and/or solidify the phase change material 106, an evaporator 110 is arranged to be thermally coupled to phase change material 106. Evaporator 110 may be formed with one or more coils which pass through or are otherwise in contact with phase change material 106. The evaporator coil(s) may form a serpentine path through the phase change material to increase surface area contact of the coils(s) with the phase change material.

A refrigerant supply tank 112 is connectable to the evaporator with a coupling which allows the user to easily connect and disconnect the supply tank. When the refrigerant in tank 112 is exhausted, the user removes the tank 112 and connects a full tank. Tank 112 is shown as being mounted to the garment on the lower front in FIG. 1, but the tank may be mounted in any suitable location including on the back of the garment. In some embodiments, the tank may be held on the user at a location separate from the garment, e.g., on a utility belt. Tanks of different shapes and sizes may be used, and a refrigerant supply does not necessarily need to be a tank, as other types of containers may be used.

An inlet valve 114 is provided for regulating refrigerant delivery from supply tank 112 to the evaporator. Control of refrigerant release from the evaporator is enabled by an outlet valve 116.

A controller 118 is provided to control one or more components of the system. The controller may be configured to control inlet valve 114 for control of refrigerant delivery to the evaporator. Outlet valve 116 also may be controlled by controller 118 as part of releasing spent refrigerant from the evaporator. In some embodiments, controller 118 may be configured to control the flow of refrigerant within different sections of the evaporator, for example by opening and closing valves which lead to distinct evaporator coils.

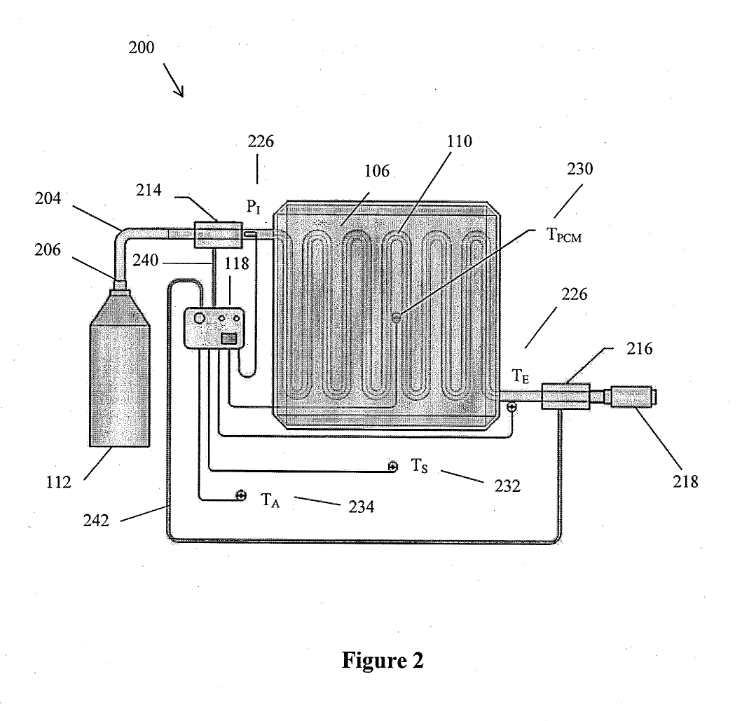

In some embodiments, the controller receives measurement information from one or more sensors, and the control of the system is based at least in part on this information. In this respect, the control of the system may be considered closed loop, while the mechanical aspects of the refrigeration system are open loop. The sensors may be configured to sense different types of parameters, such as ambient conditions, the user's vital signs, and/or system component status. Examples of ambient condition parameters include, but are not limited to, temperature and humidity. Vital sign measurements may include, for example, body temperature measurements, skin temperature readings, heart rate data, respiratory rate, blood pressure, or other data regarding the user's physiological status. Possible measurements regarding the status of various components of the system include temperature readings of evaporator components and/or the refrigerant in the evaporator. Pressure readings from the evaporator and/or the refrigerant supply are additional examples of system component status measurements. Descriptions of certain sensors and their placements within one embodiment of a cooling system are provided below with reference to FIG. 2.

The schematic diagram of FIG. 2 shows controller 118 and various mechanical components of one embodiment of a cooling system 200. Refrigerant supply 112 is connected to a flexible inlet tube 204 via a quick-connect coupling 206, though any type of coupling may be used. In some embodiments, refrigerant supply 112 may be a refillable canister that is permanently attached to inlet tube 204. An inlet electronic expansion valve 214 is positioned between the refrigerant supply and evaporator 110. Any suitable type of inlet valve or other flow control device may be used instead of, or in addition to, electronic expansion valve 214.

Evaporator 110 includes a coil which passes through phase change material 106. The coil may be high pressure capillary tubing in some embodiments. The phase change material 106 may be encapsulated within a urethane or vinyl film in some embodiments, but may be held in any suitable manner. On the outlet side of the evaporator, an outlet electronic expansion valve 216 is positioned between the evaporator and a silencer 218 to control the release of spent refrigerant from the evaporator. Any suitable type of outlet valve or other flow control device may be used instead of, or in addition to, electronic expansion valve 216. For example, in some embodiments, a bleeder valve such as a micro bleeder valve may be included at the outlet of the evaporator. Silencer 218 is provided is some embodiments to reduce the noise associated with release of the spent refrigerant.

As mentioned above, the inlet valve and/or outlet valve may be any suitable valving arrangement, including, but not limited to, electronic valves, solenoid valves, and servo rotary valves. Variable flow rate valves may be used in some embodiments, and in some embodiments normally closed, 1500 psi, 12 vdc CO₂/cryogenic solenoid valves may be used.

Through control of the introduction of refrigerant to the evaporator and control of the release of refrigerant from the evaporator, inefficient use of refrigerant may be reduced. For example, if refrigerant in the evaporator is not fully evaporating before being released from the system, the refrigerant is not being used to its full capacity. More optimally, further introduction of refrigerant to the evaporator may be postponed until most or all of the refrigerant already present in the evaporator has evaporated. Similarly, if the refrigerant within the evaporator has not fully evaporated, the outlet valve may be held closed until full (or nearly full) evaporation has occurred.

Whether the refrigerant has fully evaporated in the evaporator can be estimated or determined using temperature and/or pressure readings from inside the evaporator as both are related to the state of the refrigerant in the evaporator. Accordingly, in some embodiments, an evaporator temperature sensor 226 (T_{E}) is positioned on or within the evaporator. The temperature readings from sensor T_{E}, which may be a thermistor or other suitable sensor, may be used to determine whether liquid refrigerant remains in the evaporator. If the temperature readings show that the refrigerant exiting the system is below a threshold temperature, the presence of liquid refrigerant is indicated.

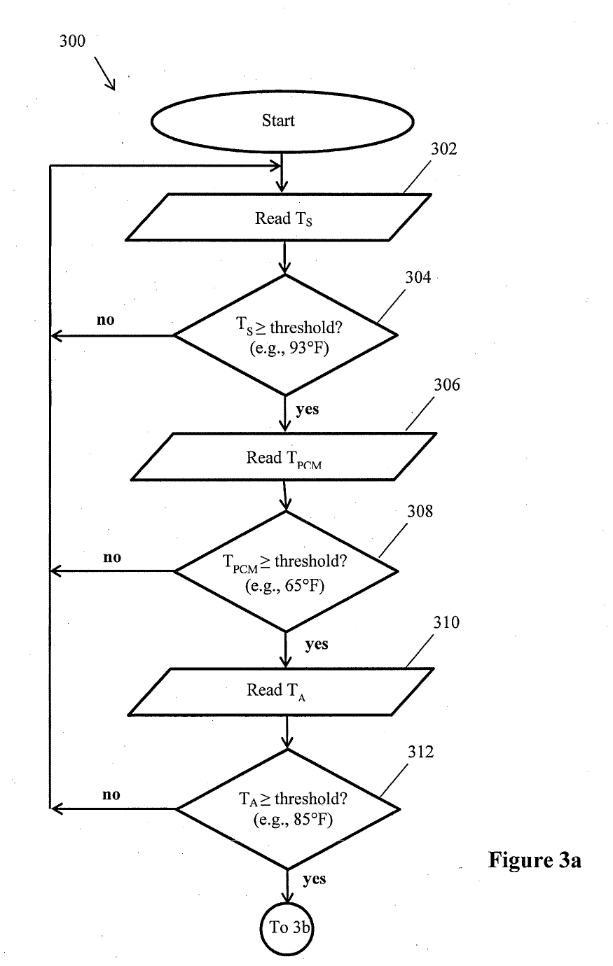

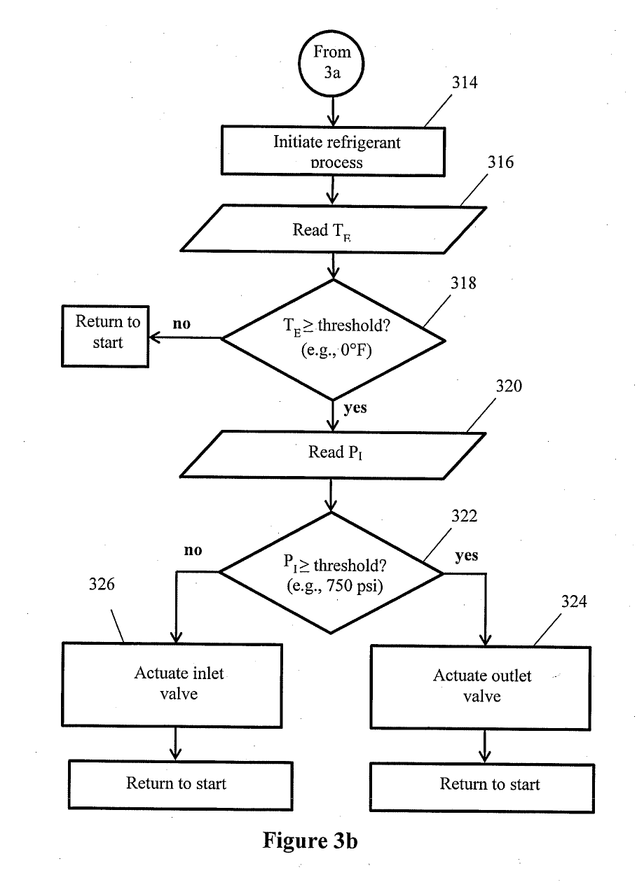

In some embodiments, an internal evaporator pressure sensor 228 (P_{I}) may be included. Using data from both sensor P_{I}228 and sensor T_{E}226, the saturation ratio of the refrigerant within the evaporator can be determined. Based at least in part on this saturation ratio, the controller controls the introduction and/or release of refrigerant. In some embodiments, the saturation ratio is not calculated, and instead a temperature threshold and/or a pressure threshold are used to control the system. For example, in the method described below with reference to FIGS. 3a and 3b, the test for the presence of liquid refrigerant is a comparison of the evaporator temperature to a threshold temperature. If the evaporator temperature is lower than the threshold temperature, no further refrigerant is added to the evaporator, nor is the evaporator outlet valve opened. In still other embodiments, both measured temperature and pressure are used as part of the determination regarding introduction and release of refrigerant, and a lookup table or an algorithm may be used to reach such determinations based on the temperature and pressure measurements.

A temperature sensor 230 (T_{PCM}) may be included in or adjacent to the phase change material or other cooling material. In some embodiments, cooling of the phase change material occurs only if the phase change material's temperature is above a certain threshold. For example, in some embodiments, if T_{PCM}230 senses a temperature of below 65° Fahrenheit for the phase change material, no additional refrigerant is added to the evaporator. Once the phase change material temperature exceeds the threshold temperature, refrigerant may be supplied to the evaporator if other conditions are met. In some embodiments, instead of, or in addition to, measuring the temperature of the phase change material, an optical sensor may be used to detect the solidity of the phase change material. For example, a micro photoelectric through-beam sensor using a laser or an LED may be used to determine when the phase change material is melting or melted.

Other sensors which may be included as part of cooling system 200 include a skin temperature sensor 232 (T_{S}) which may be placed on or adjacent the user's skin at a location that is a distance away from where the cooling material directly cools the user. In addition, or alternatively, an ambient temperature sensor 234 (T_{A}) may be used to track air temperature. This information may be used to determine the need for cooling and/or the degree of cooling that may be best suited for the ambient conditions. Ambient temperature and/or humidity sensing may permit the cooling system to react promptly to quickly changing environmental conditions, thereby avoiding the potential lag time associated with temperature changes associated with the user's skin or the cooling material.

The sensors used in some embodiments are solid state temperature sensors such as 2.2 K ohm +/−0.10° C. epoxy-coated NTC thermistors, though any suitable thermistor or other temperature sensor may be used. For example, a resistance temperature detector (RTD) or a thermocouple may be used in some embodiments.

Controller 118 may be a microcontroller or microprocessor powered by a nine volt battery or any other suitable power supply. In some embodiments, controller 118 is a Parallax® brand basic stamp test microcontroller.

Phase change material 106 may be a material with a phase point temperature of somewhere between 60° F. and 65° F. Phase change materials with phase point temperatures outside of the 60° F. to 65° F. range may be used in some embodiments. Representative phase change materials include those in the alkane family (e.g., heptadecane or hexadecane). In many applications, including when used with mobile cooling garments, between 0.25 kg and 1 kg of phase change material is used in a single system, though other masses may be used depending on the particular application. Other phase change materials may be used such as water or salt water. In some embodiments, the phase change material may include a combination of two or materials.

Any suitable phase change material may be used in various embodiments. Other examples of materials from the alkane family include decane, undecane, dodecane, tridecane, tetradecane, pentadecane, hexadecane, heptadecane, octadecane, nonadecane, eicosane, heneicosane, docosane, tricosane, tetracosane, pentacosane, hexacosane, octacosane, triacontane, and dotriacontane. Two or more these or other materials may be mixed to form a phase change material. In some embodiments, alkanes (and/or other substances) may be mixed to form a phase change material with a specific phase point temperature. Further options for phase change materials include eutectic compounds, salt hydrate, lauric acid and trimethlyolethane.

In some embodiments, the cooling material may be a material that does not change phase at the temperatures and pressures typically encountered when using the cooling system. For example, instead of an alkane, a mass of a solid which has a high ratio of specific heat to mass may be used. Or a liquid that does freeze at the temperatures produced by the evaporator may be used in some embodiments. The cooling material may be insulated on all sides except the portions configured to the cool the user in some embodiments.

When desired, to encapsulate the cooling material, such as a phase change material, polyurethane having a thickness of between 0.012 in. and 0.018 in. may be used in some embodiments, though any suitable method of supporting the cooling material may be employed.

A control line 240 functionally connects controller 118 to inlet valve 214, and a control line 242 functionally connects controller 118 to outlet valve 216. Signal lines run from each sensor to controller 118. In some embodiments, sensors having wireless communication capabilities may be used to communicate with controller 118.

A flowchart showing a method 300 of controlling an open-loop cooling system is illustrated in FIGS. 3a and 3b. Other methods including further acts, fewer acts, and different acts may be used in conjunction with cooling systems disclosed herein. Additionally, the values presented herein as threshold values are provided as examples, and different threshold values may be used, including threshold values that vary depending on various inputs.

A skin temperature value is received from T_{S}232(act 302) and compared to a threshold temperature, for example 93° F. If the measured skin temperature is less than the threshold temperature as determined in an act 304, the method returns to the start and repeats the skin temperature measurement. Reading of the sensors can occur at a fast rate, for example a thousand times per second. T_{S}232 may be positioned at any suitable location, including on the skin over the temporal artery. Body temperature may be sensed using methods other than skin temperature measurement.

Once it is determined that body temperature exceeds the threshold temperature, a temperature value for the phase change material is received from T_{PCM}230 (act 306). If the phase change material temperature is determined in an act 308 to be cooler than a threshold temperature of 65° F., the method returns to the start. If the phase change material is warmer than the threshold temperature, a measurement of ambient temperature is made in an act 310. A value is received from T_{A}234, and if the value is less than 85° F. (or other threshold temperature), the method returns to the start. The reasoning behind this decision point is that the user's body will be able to self-regulate body temperature with ambient conditions below the threshold temperature. If the ambient temperature is above the threshold in an act 312, a refrigeration process is initialized in an act 314, as shown in FIG. 3b.

A temperature value is received from T_{E}226 for the evaporator temperature at the outlet (act 316). In comparing the evaporator temperature to a threshold temperature (act 318), a temperature less than a threshold temperature (in this embodiment, 0° F.) indicates that not all of the refrigerant already present in the evaporator has evaporated, and the refrigeration process stops, and the method returns to the earlier measurement comparisons. If the evaporator temperature is determined to be warmer than the threshold temperature, the refrigeration process continues.

In an act 320, a pressure reading of internal system pressure is received from P_{I}226. If the pressure reading is greater than a threshold pressure (e.g., 750 psi), as determined in an act 322, outlet valve 216 is actuated to release spent refrigerant from the evaporator (act 324). The valve actuation may include an actuated sequence. For example, outlet valve 216 may be pulsed, and the number and timing of the pulses may be dictated by the particular pressure reading, or by on-going pressure readings.

Conversely, if the pressure reading is less than the threshold pressure, inlet valve 214 is actuated to permit delivery of refrigerant to evaporator 110. Inlet valve 214 may have a sequence initiated. For example, the valve may be pulsed, and the number and timing of the pulses may be dictated by the particular pressure reading, or by on-going pressure readings. The threshold pressure value may be set based at least in part on the particular refrigerant that is being used. Once the inlet valve and/or outlet valve sequences have been actuated, the method returns to the start.

The inlet valve and/or outlet valve sequences may continue while the controller loops through the various sensor readings. For example, in one example of a method, both the inlet valve and the outlet valve may be open, and the controller repeatedly loops through the sensor readings until the temperature of refrigerant leaving the evaporator is detected to fall below a threshold temperature. The dip in temperature indicates that liquid refrigerant is exiting the system, and the inlet valve should be closed to conserve refrigerant in the refrigerant supply.

The acts of the method described above with reference to FIGS. 3a and 3b are not limited to the particular order presented, but instead may be performed in a different order. Additionally, not all of the acts need be performed, and additional acts may be included in some embodiments.

The threshold values used for the various decisions within the method may be preset and held constant in some embodiments, however, the threshold values may be variable in other embodiments. For example, the body temperature threshold value may be tied to the measured ambient air temperature. As another example, the threshold value for phase change material temperature may be related to and vary with the measured skin temperature. In still other embodiments, the user may be able to change one or more of the threshold values.

The cooling systems disclosed herein may be controlled to continuously maintain a phase change material in a solid or semi-solid state until refrigerant supplies run out. In other embodiments, the phase change material may be allowed to substantially melt before the system uses the evaporator to draw heat from the phase change material to solidify (freeze) the material.

Various types of refrigerant may be used in the systems and methods disclosed herein. In some embodiments, liquid carbon dioxide, typically referred to as R774, is used. R774 is non-combustible, non-flammable, non-toxic and natural. In such embodiments, an aluminum carbon dioxide tank which is rated to 1800 psi may be used, or any other suitable off-the-shelf tank may be used. Of course, other suitable refrigerants may be used.

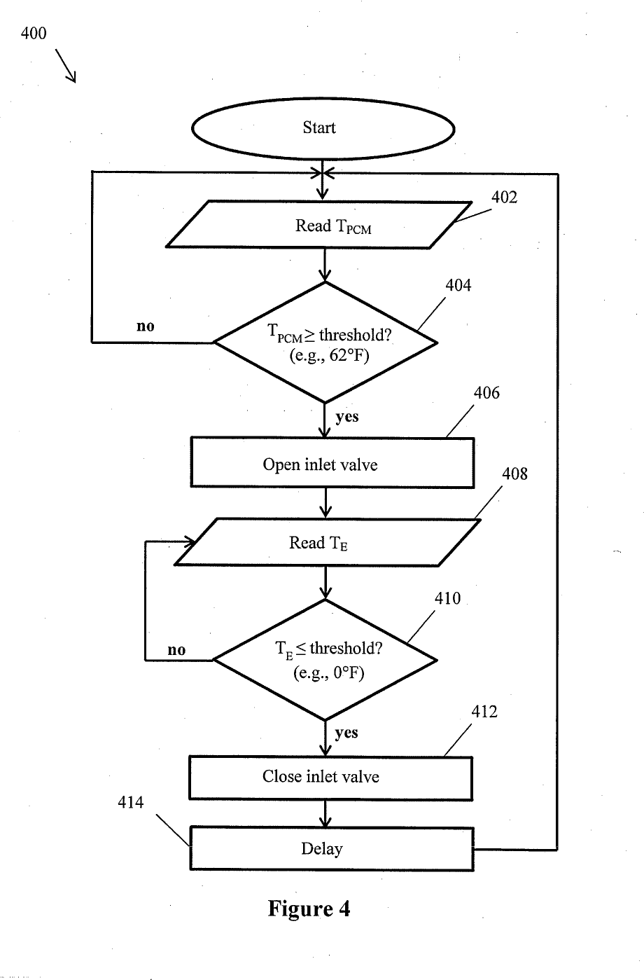

Another embodiment of a method of controlling an open-loop cooling system is illustrated by the flowchart in FIG. 4. According to a method 400, a temperature of phase change material is read in an act 402. If the phase change material is cooler than a threshold temperature (e.g., 62° F.), no action is taken and the temperature sensing continues. Once the phase change material is determined to be warmer than the threshold temperature (act 404), the inlet valve is opened to supply refrigerant to the evaporator (act 406).

The temperature of an evaporator component, or the temperature of refrigerant in or exiting the evaporator then is measured until the value is determined to be below a threshold value (act 410). This temperature comparison is used to indicate the presence of liquid refrigerant, and when detected, the inlet valve is closed in an act 412. The temperature measurement may be supplemented or substituted with an internal pressure measurement to indicate the presence of liquid refrigerant.

After the inlet valve is closed, a time delay is initiated while the refrigerant evaporates to cool the phase change material. After the time delay, the method starts again with a measurement of the phase change material temperature.

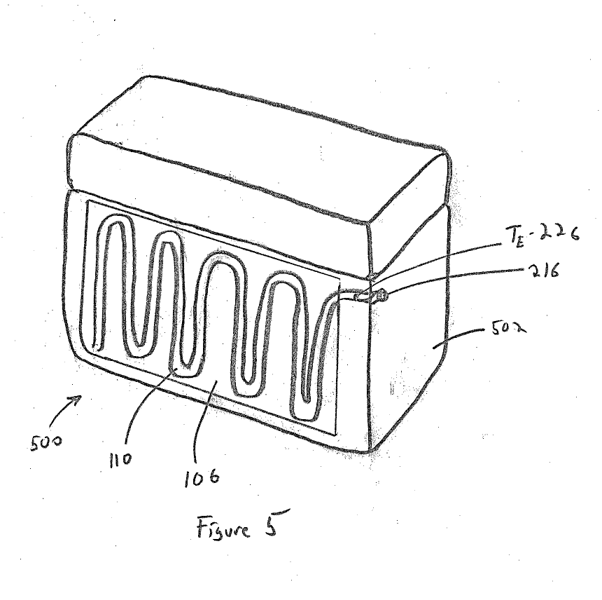

A further embodiment of a cooling system is illustrated in FIG. 5. In this embodiment, a cooling system 500 may include components similar to the systems described above, and the system is incorporated into a cooler 502 for articles. Cooler 502 may be used to store and/or transport medical items or other articles that would benefit from consistent, extended cooling. For typical use, the phase change material or other cooling material is solidified prior to use to increase the cooling time period. Though the cooling system may be used in situations where the phase change material is not pre-cooled.

The connector for the refrigerant supply container (not shown) may be positioned such that the supply container is held inside cooler 502, or within a wall of the cooler. If the supply container is held within a wall of the cooler, access may be provided from an removable exterior panel or door (not shown), so that the cooler does not need to be opened to exchange a full refrigerant supply container for a spent container.

In still further embodiments, systems and methods disclosed herein may be used to cool electrical devices or components, such as fire control computers, radar systems, or other electrical devices.

It should be understood that aspects of the invention are described herein with reference to the figures, which show illustrative embodiments in accordance with aspects of the invention. The illustrative embodiments described herein are not necessarily intended to show all aspects of the invention, but rather are used to describe a few illustrative embodiments. Thus, aspects of the invention are not intended to be construed narrowly in view of the illustrative embodiments. In addition, it should be understood that aspects of the invention may be used alone or in any suitable combination with other aspects of the invention.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A user-wearable, open-loop cooling system comprising:
an evaporator to receive a refrigerant from a refrigerant supply, and to release evaporated refrigerant;
a phase change material to be cooled by the evaporator;
a user-wearable carrier to hold the evaporator and the phase change material on a user's body;
a first sensor to sense a first property of the system, the first sensed parameter being related to a state of refrigerant which is in the evaporator or which is being released from the evaporator; and
a controller to control introduction of the refrigerant to the evaporator, wherein the control of the introduction of refrigerant to the evaporator is based at least in part on a value of the first sensed parameter.

2. The user-wearable, open-loop cooling system of claim 1, wherein the first sensed parameter comprises a temperature of a component of the evaporator.

3. The user-wearable, open-loop cooling system of claim 2, wherein the component is at or near a refrigerant outlet of the evaporator.

4. The user-wearable, open-loop cooling system of claim 2, further comprising a second sensor, the second sensor comprising a pressure sensor to sense a pressure in the evaporator.

5. The user-wearable, open-loop cooling system of claim 1, wherein the first sensed parameter comprises a temperature of the refrigerant.

6. The user-wearable, open-loop cooling system of claim 5, wherein the first sensed parameter comprising a temperature of the refrigerant in the evaporator.

7. The user-wearable, open-loop cooling system of claim 5, wherein the first sensed parameter comprises a temperature of the refrigerant being released from the evaporator.

8. The user-wearable, open-loop cooling system of claim 1, wherein the controller is configured to determine the state of the refrigerant in the evaporator based at least in part on a value of the first sensed parameter.

9. The user-wearable, open-loop cooling system of claim 1, further comprising a skin temperature sensor to be positioned to sense a temperature of the user's skin, and wherein the control of the introduction of refrigerant to the evaporator is based at least in part on a value of the sensed user's skin temperature.

10. The user-wearable, open-loop cooling system of claim 1, further comprising an inlet valve constructed and arranged to selectively introduce refrigerant to the evaporator, wherein the controller controls the inlet valve based at least in part on a value of the first sensed parameter.

11. The user-wearable, open-loop cooling system of claim 10, wherein the first sensed parameter comprises a temperature of a component of the evaporator.

12. The user-wearable, open-loop cooling system of claim 1, further comprising an outlet valve constructed and arranged to selectively release spent refrigerant from the system, wherein the controller controls the outlet valve based at least in part on a value of the first sensed parameter.

13. The user-wearable, open-loop cooling system of claim 12, wherein the first sensed parameter is a pressure in the evaporator.

14. A method cooling a user's body, the method comprising:
donning a user-wearable, open-loop cooling system, the system including:
an evaporator to receive a refrigerant from a refrigerant supply and to release evaporated refrigerant; and
a phase change material to be cooled by the evaporator;
sensing a first parameter of the system, the first sensed parameter being related to a state of the refrigerant in the evaporator; and
controlling introduction of the refrigerant to the evaporator based at least in part on a value of the first sensed parameter.

15. The method of claim 14, wherein the first parameter comprises a temperature of a component of the evaporator, and the method comprises introducing refrigerant to the evaporator only if a sensed temperature value of the evaporator component exceeds a threshold temperature value.

16. The method of claim 15, further comprising:
sensing a temperature of the phase change material; and
introducing refrigerant to the evaporator only if a sensed temperature value of the phase change material exceeds a threshold temperature value.

17. The method of claim 16, further comprising:
sensing a temperature of ambient air; and
introducing refrigerant to the evaporator only if a sensed temperature value of the ambient air exceeds a threshold temperature value.

18. The method of claim 17, further comprising:
sensing a temperature of skin of the user; and
introducing refrigerant to the evaporator only if a sensed temperature value of the user's skin exceeds a threshold temperature value.

19. The method of claim 18, further comprising:
sensing a pressure in the evaporator; and
introducing refrigerant to the evaporator only if a sensed pressure value in the evaporator is less than a threshold pressure value.

20. The method of claim 19, further comprising:
sensing a pressure in the evaporator; and
releasing spent refrigerant from the evaporator only if a sensed pressure value in the evaporator exceeds a threshold pressure value.

21. The method of claim 14, wherein the first parameter comprises a pressure in the evaporator, and the method further comprises introducing refrigerant to the evaporator only if a sensed pressure value in the evaporator is less than a threshold pressure value.

22. At least one computer-readable storage medium containing computer-readable instructions which, when executed by a processor, perform a method of controlling an open-loop cooling system, the cooling system including an evaporator to receive a refrigerant from a refrigerant supply and to release evaporated refrigerant, a phase change material to be cooled by the evaporator, and a user-wearable carrier to hold the evaporator and the phase change material on a user's body, the method comprising:
receiving a value of a first sensed parameter of the system, the first sensed parameter being related to a state of the refrigerant in the evaporator; and
controlling introduction of the refrigerant to the evaporator based at least in part on a value of the first sensed parameter.

23. The at least one computer-readable storage medium of claim 22, wherein the first sensed parameter comprises a temperature of a component of the evaporator, and the method comprises introducing refrigerant to the evaporator only if a sensed temperature value of the evaporator component exceeds a threshold temperature value.

24. The at least one computer-readable storage medium of claim 22, wherein the method further comprises:
sensing a temperature of the phase change material; and
introducing refrigerant to the evaporator only if a sensed temperature value of the phase change material exceeds a threshold temperature value.

25. The at least one computer-readable storage medium of claim 22, wherein the method further comprises:
sensing a temperature of ambient air; and
introducing refrigerant to the evaporator only if a sensed temperature value of the ambient air exceeds a threshold temperature value.

26. The at least one computer-readable storage medium of claim 22, wherein the method further comprises:
sensing a temperature of skin of the user; and
introducing refrigerant to the evaporator only if a sensed temperature value of the user's skin exceeds a threshold temperature value.

27. The at least one computer-readable storage medium of claim 22, wherein the method further comprises:
sensing a pressure in the evaporator; and
introducing refrigerant to the evaporator only if a sensed pressure value in the evaporator is less than a threshold pressure value.

28. The at least one computer-readable storage medium of claim 22, wherein the method further comprises:
sensing a pressure in the evaporator; and
releasing spent refrigerant from the evaporator only if a sensed pressure value in the evaporator exceeds a threshold pressure value.

29. The at least one computer-readable storage medium of claim 22, wherein the first parameter comprises a pressure in the evaporator, and the method further comprises introducing refrigerant to the evaporator only if a sensed pressure value in the evaporator is less than a threshold pressure value.
